(19) United States
(12) Patent Application Publication
(10) Pub. No.: US 2006/0101977 A1
(43) Pub. Date: May 18, 2006

(54) Diamond scriber

(75) Inventors: Norihiko Ito, Yuzawa-shi (JP); Kazunori Nakano, Yuzawa-shi (JP); Kenzo Inoue, Yuzawa-shi (JP)

Correspondence Address: NIXON PEABODY, LLP, 401 9TH STREET, NW, SUITE 900, WASHINGTON, DC, 20004-2128, US

(73) Assignee: Namiki Seimitsu Houseki Kabushiki Kaisha, Yuzawa-shi (JP)

(21) Appl. No.: 10/987,306

(22) Filed: Nov. 15, 2004

(51) Int. Cl. B26F 3/00

(52) U.S. Cl. 83/879; 225/96

(57) ABSTRACT

This is a diamond scriber in which the apex region of a triangular pyramid, which is a toe and/or heel of a diamond particle, is formed to a knife-edge shape that follows a ridge line connecting the toe and heel. In this way, an edge of the diamond scriber is formed to a knife-edge shape, and so it is possible to limit the spread of the slot width in the wafer, and it is possible to maintain a good quality scribe line for a longer period. Further, it is possible to prolong the lifetime of the diamond scriber.

### BACKGROUND OF THE INVENTION

The present invention relates to a diamond scriber, and particularly a diamond scriber characterized by a knife-edge shape.

Conventionally there have been diamond scribers of which the ridge line connecting the toe point and heel point is on the (111) face and the angle between the faces that meet at this ridge line is selected between 140° and 150° (see Japanese Patent Laid-Open Publication No. 47-40393).

Further, there have been eight-point diamond scribers which has the inclination angle (θ) of which the ridge line connecting the toe point and the heel point relative to the horizontal face is 55° or an angle near that (See Japanese Patent Laid-Open Publication No. 49-54987).

Moreover, there have been eight-point diamond scribers in which the delta face of which the heel point is the apex is formed on the (111) face in the Miller notation, the angle (β) of the ridge line connecting the toe point and the heel point relative to the delta face is 15° or an angle near that, and the delta face angle (α) is 46° or an angle near that (see Japanese Patent Laid-Open Publication No. 49-54988).

Further, there are scriber points of hard materials with four-way symmetry, in which there is a horizontal tip portion, a ridge line that extends from one apex of the horizontal tip portion, and a side portion that gradually spreads in the direction of the base portion with the other end of the ridge line as the apex, and in which ½ to ¼ of the length of the ridge line has been scraped from the other end in the direction of the horizontal tip portion (see Japanese Utility Model Laid-Open Publication No. 56-155452).

Nevertheless, the diamond scribers introduced in the above-described publications all have problems that after scribing repeatedly, the depth of the slot generated by scribing becomes shallow and the width of the slot spreads by abrasion of the edge.

### SUMMARY OF THE INVENTION

The present invention has been devised in view of the above-described problem points, and an object of the present invention is to provide a diamond scriber that can maintain an excellent scribe line for a longer period.

According to the present invitation, there is provided a diamond scriber, in which an apex region of a triangular pyramid, which is a toe and/or heel of a diamond particle, is formed to a knife-edge shape along a ridge line connecting the toe and heel.

Accordingly, since the edge of the diamond scriber is formed to a knife-edge shape, it is possible to limit the spread of scribe line width.

According to a preferred embodiment, a width of the knife-edge shape is in a range from 5 μm to 15 μm.

Accordingly, it is possible to draw a scribe line with a narrow width between 5 μm and 15 μm, even with repeated scribing.

According to another preferred embodiment, a height of the knife-edge shape is at least 2 μm.

Accordingly, it is possible to prolong the lifetime of the diamond scriber, in proportion to the height of the knife-edge shape.

According to another preferred embodiment, the knife-edge shape is formed by scraping two ridges except said ridge line of the triangular pyramid along said ridge line.

Accordingly, the appropriate knife-edge shape can be formed properly.

### BRIEF DESCRIPTION OF THE DRAWINGS

FIGS. 1A, 1B and 1C are enlarged views of a diamond particle that is mounted on a diamond scriber.

FIG. 2A, an enlarged view of a region A of FIGS. 1A, 1B and 1C, is a concept diagram illustrating a shape of an edge machined to a knife-edge shape. And FIG. 2B is a side view of FIG. 2A.

FIG. 3A, an enlarged view of the region A of FIGS. 1A, 1B and 1C, is a concept diagram illustrating the amount of wear of the edge machined to a knife-edge shape. And FIG. 3B is a side view of FIG. 3A.

FIG. 4A, an enlarged view of the region A of FIGS. 1A, 1B and 1C, is a concept diagram illustrating the amount of wear of a conventional edge. And FIG. 4B is a side view of FIG. 4A.

### DETAILED DESCRIPTION OF THE INVENTION

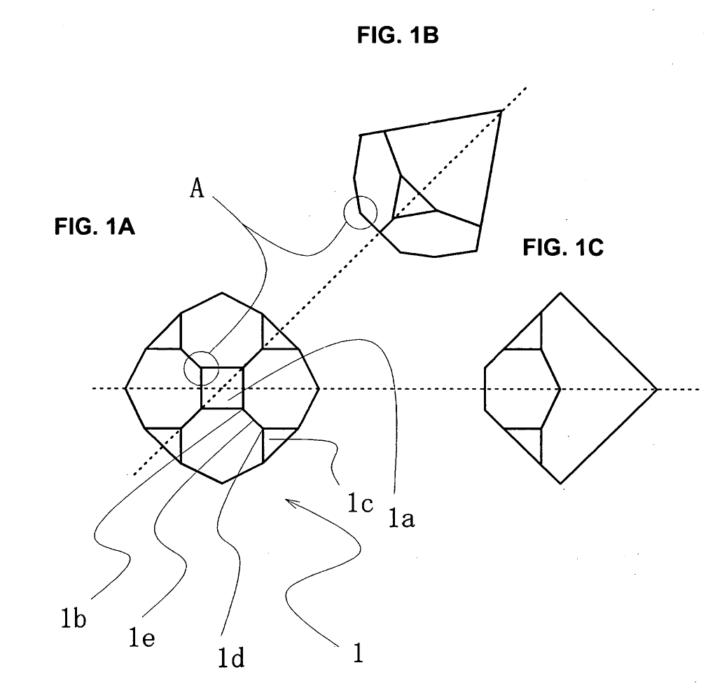

A diamond particle 1 illustrated in FIGS. 1A, 1B and 1C is mounted on the tip of the diamond scriber. This diamond particle 1 is an eight-point scriber to which toe 1b is formed on each corner of a horizontal face 1a as illustrated in FIG. 1A, and a heel 1d is formed in an apex of delta face 1c. A ridge line 1e connects the toe 1b and the heel 1d.

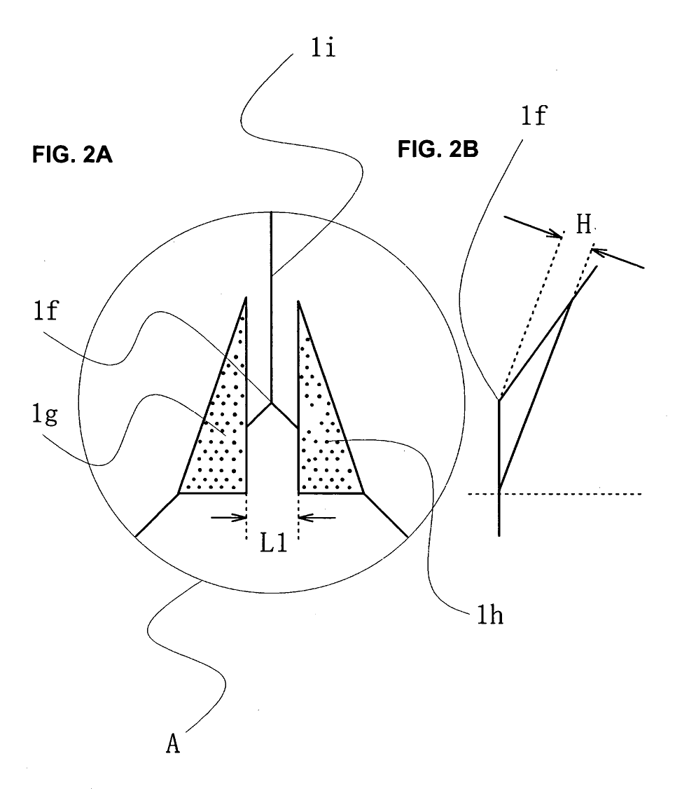

The knife-edge shaped toe, which is the major part of the present invention, is explained here on the basis of FIG. 2A, which is an enlarged view of the toe region A of the diamond particle 1. Now, the optimum mode of implementation of the present invention is explained with regard to the shape of the toe, but in the present invention the shape of the heel can be shaped as well.

As illustrated in FIGS. 2A and 2B, two ridges 1g, 1h of the triangular pyramid of which the apex is the toe 1f of the diamond particle 1 are scraped along the ridge line 1i that connects the toe 1f and the heel; by this means it is possible to shape the triangular pyramid, of which the apex is the toe 1f, into a knife-edge shape. To inscribe a sapphire wafer, it is desirable to scrape the ridges 1g, 1h of the triangular pyramid so that the width L1 of the knife-edge shape is about 8 μm and the height H of the knife-edge shape is about 5 μm.

Now, because the appropriate dimensions of the knife-edge shape width L1 and height H vary depending on the wafer material, the dimensions of the knife-edge shape width L1 and height H in the present invention are not limited to the dimensions above. Further, the diamond scriber of the present invention is not limited to a four-point scriber or an eight-point scriber; the present invention can be applied to any diamond scriber in which the edge has a triangular pyramid, which has the toe as its apex.

Next, the inscribing of a sapphire wafer using the diamond scriber illustrated in FIGS. 1A, 1B, 1C and 2A, 2B (test case) is explained in contrast to inscribing using an ordinary scriber without knife-edge shape processing.

[Test Case]

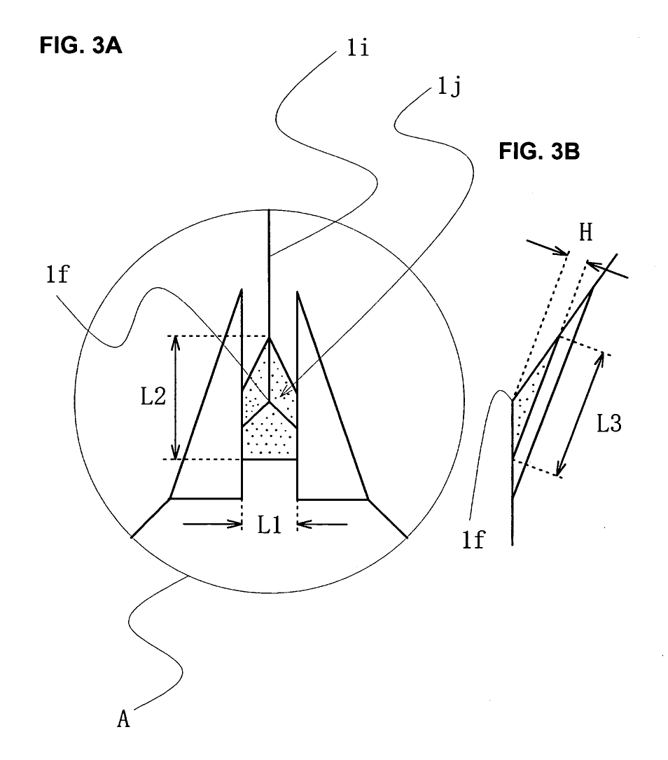

A sapphire wafer was inscribed repeatedly using the diamond scriber illustrated in FIGS. 1 and 2, until a good scribe line was no longer drawn, and the worn-out portion of the knife-edge was measured. The dimensions of the knife-edge worn-out portion 1j at the limit of usability, as illustrated in FIGS. 3A and 3B, are illustrated below.

| | | |
|---|---|---|
| Width L1 | 8.0 | μm |
| Length L2 | 18 | μm |
| Length L3 | 19.16 | μm |
| Height H | 2.97 | μm |

Because the edge of the diamond scriber illustrated in the test case is machined into a knife-edge shape, it is possible to draw a fine scribe line of 8.0 μm or less in width until the height H wears out to 2.97 μm. In other words, it is possible to repeatedly pull a fine scribe line of 8.0 μm or less in width, and also the lifetime of the diamond scriber can be prolonged.

[Control Case]

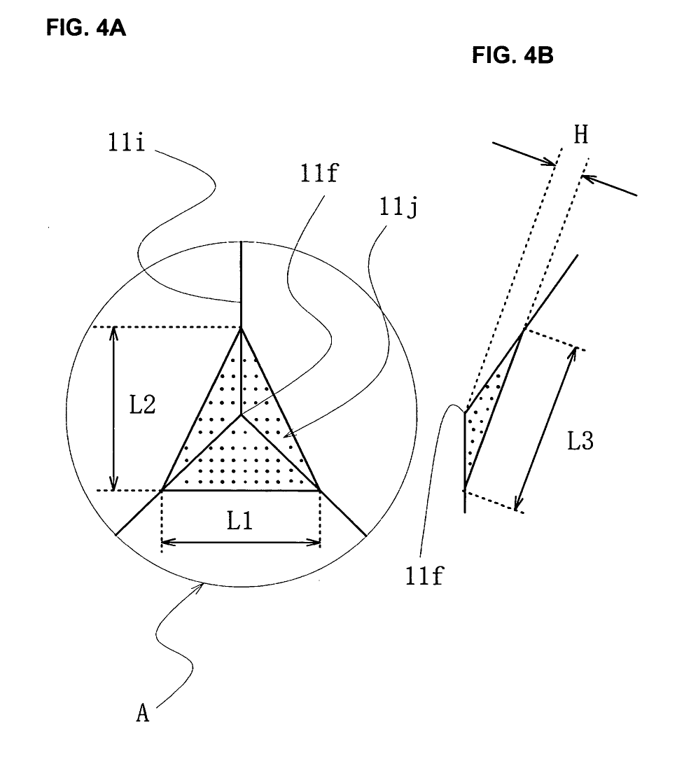

A sapphire wafer was inscribed repeatedly using an ordinary diamond scriber not machined into a knife-edge shape, until a good scribe line was no longer drawn, and the worn-out portion of the edge was measured. The dimensions of the edge worn-out portion 11j at the limit of usability, as illustrated in FIGS. 4A and 4B, are illustrated below.

| | | |
|---|---|---|
| L1 | 8.5 | μm |
| Length L2 | 9 | μm |
| Length L3 | 9.58 | μm |
| Height H | 1.49 | μm |

Because the knife edge of the diamond scriber illustrated in the control case is not machined into a knife-edge shape and remains in the shape of a triangular pyramid, if it is used until the height H of the worn-out portion reaches 1.49 μm, the worn-out portion causes the edge to spread toward the base of the triangular pyramid, and it becomes impossible to draw a fine scribe line of 8.5 μm or less in width.

As stated above, when the height H of the worn-out portion of the test case is compared with the height H of the worn-out portion of the control case, it is clear that the diamond scriber of the test case has a longer lifetime, and a scribe line with good quality can be made longer.

When inscribing sapphire wafers using the diamond scriber of the present invention, it is possible to maintain a scribe line with good quality for a longer period. In other words, it is possible to prolong the lifetime of the diamond scriber.

What is claimed is:

1. A diamond scriber, in which an apex region of a triangular pyramid, which is a toe and/or heel of a diamond particle, is formed to a knife-edge shape along a ridge line connecting the toe and heel.

2. The diamond scriber as described in claim 1, wherein a width of said knife-edge shape is in a range from 5 μm to 15 μm.

3. The diamond scriber as described in claim 1 or 2, wherein a height of said knife-edge shape is at least 2 μm.

4. The diamond scriber as described in claim 1, wherein said knife-edge shape is formed by scraping two ridges except said ridge line of said triangular pyramid along said ridge line.
